(19) United States
(12) Patent Application Publication
(10) Pub. No.: US 2004/0076385 A1
(43) Pub. Date: Apr. 22, 2004

(54) Optical connector

(75) Inventors: Kazuhiro Asada, Nagoya-shi (JP); Hayato Yuuki, Nagoya-shi (JP); Yuji Nakura, Nagoya-shi (JP); Momoe Yagi, Nagoya-shi (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., Nagoya-shi (JP); SUMITOMO WIRING SYSTEMS, LTD., Yokkaichi-city (JP); SUMITOMO ELECTRIC INDUSTRIES, LTD., Osaka-shi (JP)

(21) Appl. No.: 10/680,786

(22) Filed: Oct. 8, 2003

(30) Foreign Application Priority Data
Oct. 16, 2002 (JP) 2002-301763
Nov. 1, 2002 (JP) 2002-319615
Nov. 7, 2002 (JP) 2002-323760

(51) Int. Cl. G02B 6/36

(52) U.S. Cl. 385/92

(57) ABSTRACT

An optical connector electrically connects a surface-implemented type optical element held at a position separated by a predetermined distance from a wiring substrate and a wiring pattern of the wiring substrate. A surface-implemented type optical element is held at a height position apart from the bottom of the connector housing by a predetermined distance within an element-storing depression of the connector housing. The back of the element-storing depression has an opening that is closed by a lid portion. A lead frame is provided in the lid portion. A connecting portion on one end of the lead frame is in contact with an electrode portion of the optical element within the element-storing depression. A soldering portion on an other end of the lead frame is exposed to the outside of the connector housing to be soldered to a wiring pattern of a wiring substrate. A lock-associating portion with a lock piece is integrally provided on the bottom surface side of the connector housing. The lock piece is supported at a position separated from the bottom surface side of the connector housing by a distance equal to the thickness of a wiring substrate. By sliding an optical connector on the wiring substrate, the lock piece is abutted to the lower surface side of the wiring substrate to prevent lifting the connector housing from the wiring substrate. The optical element is held in the element-storing depression of the connector housing to be optically connected to an optical fiber held by the optical connector of the other party. The optical element is surface-mounted on an implementation-extending portion of the wiring substrate, and is inserted from the back side opening to be laid in the element-storing depression.

### CLAIM FOR PRIORITY

The present invention claims priority to Japanese Patent Applications JP-A2002-301763 filed Oct. 16, 2002, JP-A-2002-319615 filed Nov. 1, 2002, and JP-A2002-323760 filed Nov. 7, 2002.

### BACKGROUND OF THE INVENTION

1. Field of Invention

The present invention relates to an optical connector used in the optical communication field for OA, FA and car-mounted equipment.

2. Description of Related Art

A conventional optical connector containing an optical element may be implemented on a substrate. See JP-A-2001-296455, for example. The optical connector is connected to an optical connector holding an optical fiber of the other party so as to obtain the optical connection between the optical finer and the optical element.

In this kind of optical connector, the optical element has a lead terminal laid in an optical-element body portion for receiving or emitting light. The optical-element body portion is stored and held at the height apart from the surface of the substrate by a predetermined distance within a connector housing. Then, the optical-element body portion is soldered and electrically connected therefrom to the wiring pattern of the substrate through the lead terminal.

In the conventional optical connector, the connector housing itself is designed to guide the optical fiber held in the connector of the other party to the position apart from the substrate by a predetermined distance. In this kind of optical connector, the optical element has a lead terminal laid in an optical-element body portion for receiving or emitting light.

In such a conventional optical connector, an optical element with a lead terminal is stored at a position apart from the substrate by a predetermined distance in a connector housing implemented and fixed on the substrate. The optical element is electrically connected to a pattern of the wiring substrate through the longer lead terminal.

However, in the optical connector, the longer lead terminal exists between the body portion of the optical element and the substrate in order to connect the optical element within the housing and the substrate outside the housing. In this case, the occurrence or entry of noise from the lead terminal is a problem.

When a smaller, surface-implemented type optical element is applied to the optical connector, the optical element is stored at a position apart from the substrate by a predetermined distance. Therefore, the electrode portion provided in the optical-element body portion cannot reach the wiring substrate, and the surface-implemented type optical element cannot be soldered to the wiring substrate, which is a problem.

Here, an optical connector may be newly designed to be stored and held at a position at which a surface-implemented type optical element can be implemented on the surface of the wiring substrate. However, in this case, not only the optical connector to be implemented on the wiring substrate, but also the optical connector on the other party to be connected thereto must be largely changed in design.

An optical element may be of a smaller, surface-mounted type. In order to apply this to the above-described optical connector, a connector housing may be adopted in which the surface-mounted type optical element is stored and held at a position where the optical element can be surface-mounted on the wiring substrate.

However, in this case, when a force lifting the housing from the wiring substrate is applied to the connector housing, the force is directly applied to the soldering part between the optical element and the wiring substrate. This force may cause problems, such as cracks in the soldering part, for example.

### SUMMARY OF THE INVENTION

It is an object of the invention to provide an optical connector having an excellent securing strength in the lifting direction from the wiring substrate. The present invention also provides an optical connector having excellent noise resistance.

The present invention has been made in view of the above-described problem. Accordingly, the present invention provides a terminal box apparatus for a solar cell module having improved durability and reliability for long-term service.

The invention provides an optical connector, which can electrically connect a surface-implemented type optical element and a wiring pattern on the wiring substrate side, the optical element being held at a position apart from a wiring substrate by a predetermined distance.

In order to solve the problem, the invention provides an optical connector storing an optical element and being implemented on a wiring substrate. The optical connector includes a surface-implemented type optical element having an optical element body portion and an electrode portion provided in the optical element body portion. The optical connector also includes a connector housing, which can hold the optical element so as to optically connect the optical element to an optical fiber. The connector housing may contain a conductive material.

The optical fiber is held in an optical connector of an other party at a position apart from the main surface of the wiring substrate by a predetermined distance, and the optical connector has an element-storing depression having an opening on the back. The optical connector includes a lid portion for closing the opening on the back of the element-storing depression, and a lead frame mounted to the lid portion. The optical connector has a connecting portion electrically connected to an electrode portion of an optical element stored in the element-storing depression on one end, and a soldering portion that can be soldered to wiring of the wiring substrate, on the other end.

The optical element has an element-storing depression having on the bottom side an opening to which the optical element can be inserted. The optical connector also includes a lead frame, provided on the inner radius surface of the element-storing depression, having a connecting portion electrically connected to the electrode portion of the optical element stored in the element-storing depression on one end, and a soldering portion, which can be soldered to a wiring of the wiring substrate, on the other end. The lead frame may have a forcing portion for press-forcing the connecting portion to the electrode portion of the optical element.

The bottom surface side of the connector housing has a lock-associating portion having a lock portion, which extends toward the bottom surface and which can associate with the other main surface side of the wiring substrate and a support portion for supporting the lock piece at a position separated from the bottom surface side of the connector housing by the distance equal to the thickness of the wiring substrate.

The lock portion may extend from the support portion in the connection direction of an optical connector of the other party. Also, a positioning associating portion may be provided between the bottom surface of the connector housing and the lock portion.

The optical element is implemented on the wiring substrate. The part of the wiring substrate where the optical element is implemented and the optical element are stored in the connector housing. The connector housing may contain a conductive material.

The connector housing may have an element-storing depression, which opens at the back, and the wiring substrate may have an implementation-extending portion to be inserted to the element-storing depression. The optical element may be implemented to the implementation-extending portion and be stored together with the implementation-extending portion in the optical element storing portion by being inserted from the back.

### BRIEF DESCRIPTION OF THE DRAWINGS

Various exemplary embodiments of the devices, systems and methods of this invention will be described in detail with reference to the following figures, wherein:

FIG. 1 is a perspective diagram showing an optical connector according to a first embodiment of the invention;

FIG. 2 is a section diagram showing the optical connector;

FIG. 3 is a perspective diagram showing a connector housing of the optical connector;

FIG. 4 is a perspective diagram showing a lid portion of the optical connector;

FIG. 5 is an assembly section diagram of the optical connector;

FIG. 6 is a section diagram showing another optical connector also using the connector housing;

FIG. 7 is a section diagram showing an optical connector according to a variation example;

FIG. 8 is an assembly section diagram of the optical connector;

FIG. 9 is a perspective diagram showing an optical connector according to a second embodiment;

FIG. 10 is a section diagram showing the optical connector;

FIG. 11 is a section diagram showing a connector housing of the optical connector;

FIG. 12 is a section diagram showing an optical connector according to a third embodiment of the invention;

FIG. 13 is a perspective diagram for describing a state where the optical connector is mounted to the wiring substrate;

FIG. 14 is a section diagram showing a step for implementing and fixing the optical connector to the wiring substrate;

FIG. 15 is a section diagram showing another step for implementing and fixing the optical connector to the wiring substrate;

FIG. 16 is a perspective diagram for describing a state where an optical connector according to a variation example is mounted to a wiring substrate;

FIG. 17 is a perspective diagram showing an optical connector according to a fourth embodiment and an optical connector of the other party to be connected thereto; and

FIG. 18 is a section diagram showing the connection state of both of the optical connectors.

### DETAILED DESCRIPTION OF EXEMPLARY EMBODIMENTS

First Embodiment

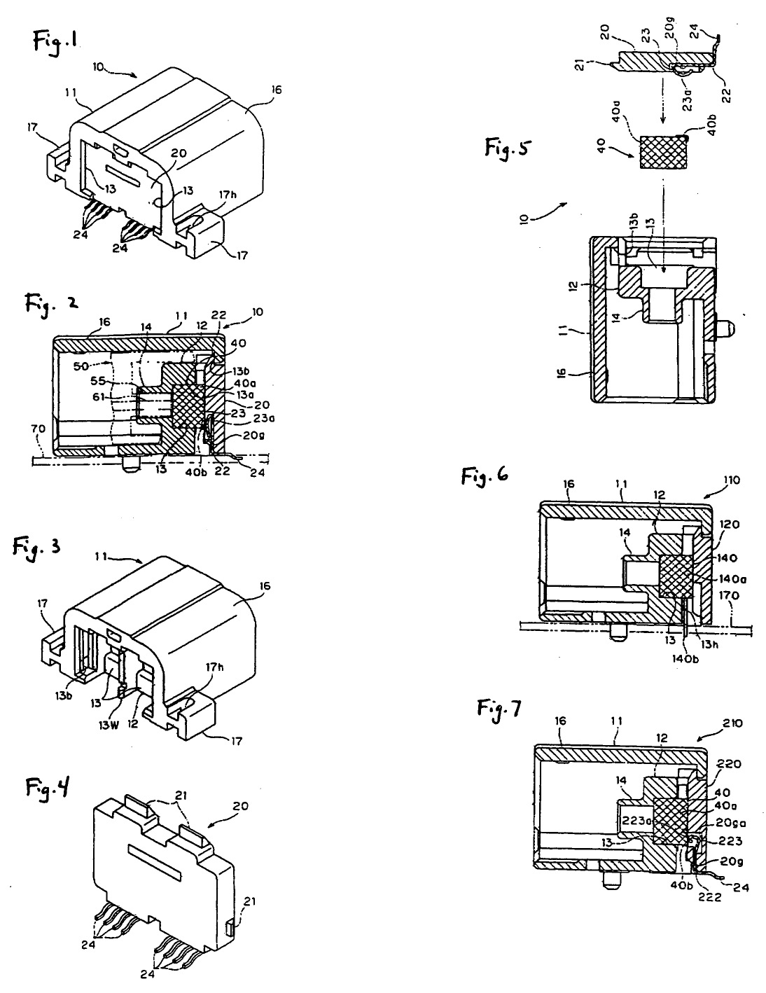

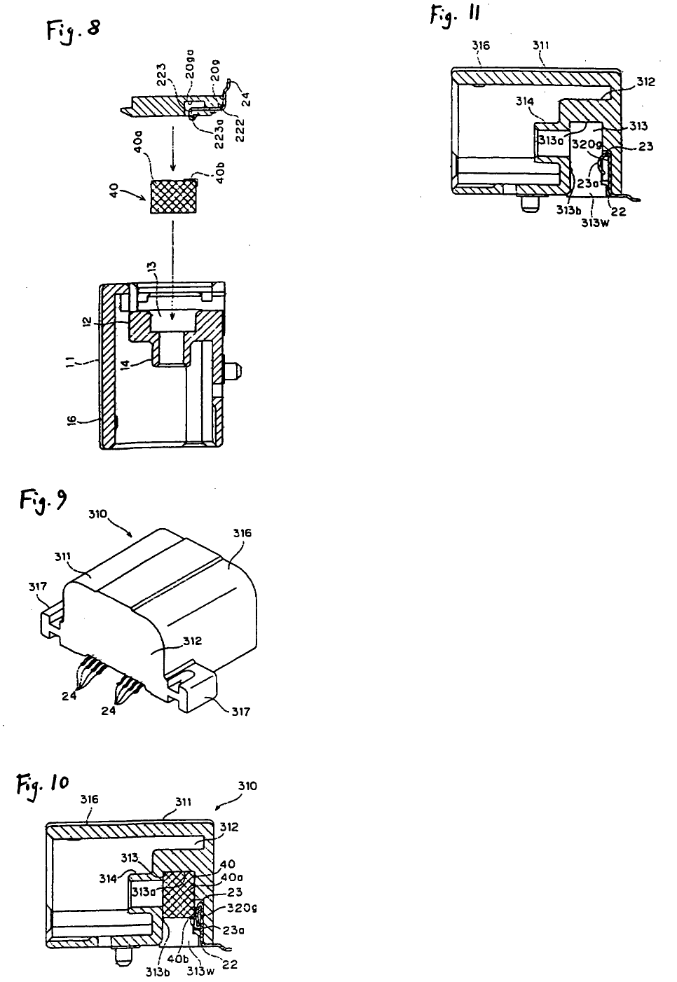

An optical connector according to a first embodiment of the invention will be described below. FIG. 1 is a perspective diagram showing an optical connector. FIG. 2 is a section diagram showing an optical connector. FIG. 3 is a perspective diagram showing a connector housing. FIG. 4 is a perspective diagram showing a lid portion. FIG. 5 is an assembly section diagram of the optical connector.

An optical connector 10 contains an optical element 40 and is implemented on a wiring substrate 70. With the implemented state, an optical connector 50 holding an optical fiber 61 of the other party can be connected to the optical connector 10 (see FIG. 2). The optical connector 10 includes an optical element 40, a connector housing 11 and a lid portion 20.

The optical element 40 is a light-receiving element (such as a photo diode and a phototransistor) for converting optical signals to electric signals or a light-emitting element (a light-emitting diode and the like) for converting electric signals to optical signals. The optical element 40 is of the surface-implemented type. The optical element 40 has an electrode portion 40b on the surface of an optical element body portion 40a. More specifically, the optical element 40 has the thin-band-shaped electrode portion 40b on the surface of the lower back of the optical element body portion 40a (see FIGS. 2 and 5). According to this embodiment, the optical connector 10 has two optical elements 40.

As shown in FIGS. 1 to 3 and 5, the connector housing 11 is made of resin or the like and contains two element-storing depressions 13, which can store and hold the optical elements 40. More specifically, the connector housing 11 includes the housing body portion 12, a sleeve portion 14 and a connecting tube 16.

The housing body portion 12 contains two element-storing depressions 13, each of which can store each of the optical elements 40. These two element-storing depressions 13 are separated by a separating wall 13W (see FIG. 3).

Each of the element-storing depressions 13 is higher than the optical element 40. The upper surface of each of the optical elements 40 is abutted to the ceiling surface 13a of each of the element-storing depressions 13. Thus, the bottom surface of the optical element 40 is separated from the bottom surface (which substantially agrees with the main surface of the wiring substrate 70) of the connector housing 11 by a predetermined distance. Then, the optical element 40 can be stored therein (see FIG. 2). The amount of space between the bottom surface of the connector housing 11 and the bottom surface of the optical element 40 is defined in consideration of a space required for the lead terminal of the optical element 40 to be held when the optical element with the lead terminal is contained within the element-storing depression 13 (see FIG. 6).

Each of the optical elements 40 within the respective element-storing depression 13 is held so as to be connected to the optical fiber 61 held in the optical connector 50 of the other party. In other words, two sleeve portions 14 are projected toward the front of the housing body portion 12. Each of the sleeve portions 14 has a substantial-tube shape having a hole, through which a ferrule portion 55 of the optical connector 50 of the other party can be inserted and which communicates to the inside of each of the element-storing depression 13. When the optical connector 10 and the optical connector 50 are connected, each of the ferrule portions 55 is laid within the respective sleeve portion 14 and is guided toward the optical element 40 of the respective element-storing depression 13. When each of the ferrule portions 55 is completely inserted to the respective sleeve portion 14, the end front of the optical fiber 61 faces and optically connects to the light emitting or light receiving surface of the respective optical element 40.

The element-storing depression 13 opens toward the back side (opposite side of the side to which the optical connector 50 of the other party is connected) of the connector housing 11. The optical element 40 is inserted from the back side into the respective element-storing depression 13 such that the optical element 40 can be stored and held in a predetermined position where the light-receiving or light-emitting surface can face forward. The openings of the backs of the element-storing depressions 13 connect to each other on the back side of the connector housing 11. The lid portion 20 is mounted to the opening on the back side.

The connecting tube portion 16 extends so as to enclose both of the sleeve portions 14 from the outer radius part of the housing body portion 12. The connecting tube portion 16 has substantially a tube-shape, to which the optical connector 50 of the other party can internally fit. Furthermore, screwed portions 17 project on both sides of the outer radius part of the housing body portion 12. Each of the screwed portions 17 has a screw hole 17h.

As shown in FIGS. 1, 2, 4 and 5, the lid portion 20 is a plate-like shape corresponding to the opening of the back of the element-storing depression 13, and the opening can be closed.

An associating projection 21 is provided on the outer radius part of the lid portion 20 (see FIG. 4), and an associated portion 13b with which the associating projection 21 can associate is provided on the outer radius part of the opening on the back of the element-storing depression 13 (see FIGS. 2, 3 and 5). The associating projection 21 is associated with the associated portion 13b so that the lid portion 20 can be attached to the opening on the back of the element-storing depression 13. Under this condition, the front surface of the lid portion 20 is abutted to the back of the optical element 40 within the element-storing depression 13 such that the lid potion 20 can keep the respective optical element 40 within the element-storing depression 13.

A frame storing slot portion 20g is provided vertically on the front surface of the lid portion 20, i.e., on the surface facing the optical element 40. A lead frame 22 is attached to the frame storing slot portion 20g. The lead frame 22 may be attached to the lid portion 20 by being fitted into the frame storing slot portion 20g or by being embedded in the lid portion 20 through insert molding. The number of lead frames 22 is equal to the number of the electrode portions 40b of both of the optical elements 40.

The lead frame 22 is obtained by bending a conductive line material of copper or soft copper, for example. A connecting portion 23 is provided on one end. The connecting portion 23 can be abutted to the electrode portion 40b of the optical element 40. A soldering portion 24 is provided on the other end. The soldering portion 24 can be soldered to the wiring pattern of the wiring substrate 70.

The connecting portion 23 has a bend-forcing portion 23a. The bend-forcing portion 23a is obtained by folding one end of the line material toward the optical element 40 side and by bending the folded part in an arc shape. The base end part supporting the bend-forcing portion 23a of the connecting portion 23 is provided so as to be tightly in contact with the bottom of the frame storing slot portion 20g. One end portion of the lead frame 22 is prevented from being elastically deformed in a direction apart from the optical element 40. The optical element 40 is stored in the respective element-storing depression 13, and the lid portion 20 is attached to the opening on the back of the respective element-storing depression 13. Thus, the top of the bend-forcing portion 23a is press-fitted to the electrode portion 40b of the optical element 40, and the bend-forcing portion 23a is elastically deformed into a flat form. With the elasticity of the bend-forcing portion 23a for returning to the original form, the bend-forcing portion 23a is pressed and is forced to the electrode 40b so as to obtain the electric connection between them.

The soldering portion 24 is exposed to the outside of the connector housing 11 so as to be soldered to the wiring pattern of the wiring substrate 70. More specifically, the soldering portion 24 extends toward the bottom edge of the lid portion 20, bends toward the back side at the bottom edge and extends toward the outside from the back side of the lid portion 20. The optical connector 10 is provided on the wiring substrate 47, and the soldering portion 24 is in contact with and can be soldered to a predetermined wiring pattern on the wiring substrate 70.

In order to assemble the optical connector 10, the optical element 40 is stored in the respective element-storing depression 13 of the connector housing first of all. Then, the lid portion 20 is attached to the opening of the back of the element-storing depression 13. Then, the optical element 40 is held at a predetermined position within the element-storing depression 13. Furthermore, the lead frame 22 is electrically connected to the respective electrode portion 40b of the optical element 40. In this way, the optical connector can be assembled.

In order to implement the optical connector 10 on the wiring substrate 70, the soldering portion 24 extending to the back of the optical connector 10 is positioned in accordance with the position of a predetermined wiring pattern on the wiring substrate 70. Furthermore, the screw hole 17h of the screwed portion 17 is positioned in accordance with the position of the screw hole of the wiring substrate 70. Thus, the optical connector 10 is mounted on the wiring substrate 70.

Under this condition, the soldering portion 24 is soldered to the predetermined wiring pattern on the wiring substrate 70 by using a reflow soldering method, for example. Then, the screwed portion 17 is screwed to the wiring substrate 70. In this case, either the soldering or the screwing may be performed first. This completes implementation of the optical connector 10 to the wiring substrate 70.

In the optical connector 10 having the above-described construction, the connecting portion 23 of one end of the lead frame 22 provided in the lid portion 20 is electrically connected to the electrode portion 40b of the optical element 40 within the element-storing depression 13. The soldering portion 24 of the other end of the lead frame 22 can be soldered to the wiring pattern of the wiring substrate 70. Therefore, the surface-implemented type optical element 40 held at a position apart from the wiring substrate 70 by a predetermined distance and the wiring pattern of the wiring substrate 70 can be electrically connected.

Thus, only by slightly deforming in design a conventional optical connector designed to store and hold the element body portion at a position apart from the substrate based on the premise that the optical connector includes an optical element with a lead terminal, the optical connector for a surface-implemented type optical element 40 can be manufactured. The optical connector of the other party connecting thereto may have the same construction as the conventionally used one.

The connecting portion 23 is press-forced against the electrode portion 40b by the force using the elastic restoring force of the bend-forcing portion 23a. Therefore, the connection reliability between the connecting portion 23 and the electrode portion 40b can be obtained.

Even when one having a size and/or form slightly different from those of the originally designed optical element 40 is stored within the element-storing depression 13, the difference can be absorbed in accordance with the degree of the elastic deformation of the bend-forcing portion 23a. Thus, the connecting portion 23 can be abutted to and electrically connected to the electrode portion 40b. Therefore, the optical element 40 having a slightly different size and/or form can be addressed.

In particular, the lid portion 20 of the optical connector 10 may be replaced by a lid portion 120 without the lead frame 22 the optical connector 10 can thus be used as an optical connector 110 for an optical element 140 with a lead terminal 140b. FIG. 6 is a section diagram showing the optical connector 110. In the optical connector 110, the connector housing 11 having the same construction as the above-described one and the lid portion 120 having the same construction as the lid portion 20 except for the lead frame 22 are used. The optical element 40 has the construction where a lead terminal 140b is vertically provided in an optical element body portion 140a. The optical element body portion 140a has substantially the same form and size as those of the element body portion 40a.

The optical-element body portion 140a is stored in the element-storing depression 13. The lead terminal 140b is extended below the connector housing 11 through an inserting depression 13h below the element-storing depression 13. When the lid portion 120 is attached to the opening at the back of the element-storing depression 13 under this condition, the optical element 140 is stored and held within the respective element-storing depression 13.

In order to implement the optical connector 110 on the wiring substrate 170, the lead terminal 140b is inserted through the through-hole formed on the wiring substrate 170. Then, the lead terminal 140b is soldered by using the flow soldering method, for example, to a predetermined wiring pattern on the bottom side of the wiring substrate 170.

In other words, in the optical connector 10 according to the first embodiment, the surface-implemented type optical element 40 is held at a position apart from the top surface of the wiring substrate 70 by a predetermined distance. Thus, the connector housing 11 can be used as the optical connector 110 for the optical element 120 with a lead terminal, which is an advantage.

A variation example of the optical connector 10 according to the first embodiment will be described. FIG. 7 is a section diagram showing an optical connector 210 according to the variation example. FIG. 8 is an assembly section diagram of the optical connector 210.

Here, only the differences between the optical connector 10 and the optical connector 210 will be described. In the optical connector 210, one end of the line material of the connecting portion 223 of the lead frame 222 is bent substantially at the right angle. The pointed end has a contact 223a bent substantially in a U-shape. The connecting portion 223 has a retractable retraction depression 20ga at the part corresponding to the connecting portion 223 in a frame storing slot 20g of a lid portion 220. The base end part of the connecting portion 223 is mounted and is supported by the lid portion 220. The lead frame 222 is elastically deformed at the base end part of the connecting portion 223. Thus, the connecting portion 223 is retractable within the retraction depression 20ga.

In the optical connector 210, the optical element 40 is stored within the element storing portion 13, and the lid portion 220 is attached to the opening on the back of the element-storing depression 13. Thus, the contact 223a is pressed against the electrode portion 40b of the optical element 40. The lead frame 222 is elastically deformed at the base end part of the connecting portion 223. Then, the connecting portion 223 is slightly retracted into the retraction depression 20ga. Under this condition, the connecting portion 223 is press-forced against the electrode portion 40b of the optical element 40 by using the force that the base end part of the connecting portion 223 tries to return to the original straight line. In other words, the base end part of the connecting portion 223 in the lead frame 222 functions as a forcing portion for press-forcing the connecting portion 223 to the electrode portion 40b.

According to this embodiment, the optical connector 10 is of a so-called bipolar type including two optical elements 40. However, the optical connector having one pole or three or more poles is applicable.

Second Embodiment

An optical connector according to a second embodiment of the invention will be described below. FIG. 9 is a perspective diagram showing an optical connector. FIG. 10 is a section diagram showing the optical connector. FIG. 11 is a section diagram showing an optical connector, which does not store an optical element.

An optical connector 310 includes an optical element 40 having the same construction as the one according to the first embodiment, a connector housing 311 and a lead frame 22.

The connector housing 311 is made of resin or the like and contains two element-storing depressions 313, which can store and hold the optical elements 40. More specifically, the connector housing 311 includes the housing body portion 312, a sleeve portion 314 and a connecting tube portion 316.

The housing body portion 312 contains two element-storing depressions 313, each of which can store each of the optical elements 40. These two element-storing depressions 313 are separated by a separating wall 313W.

Each of the element-storing depressions 313 is higher than the optical element 40. The upper surface of each of the optical elements 40 is abutted to the ceiling surface 313a of each of the element-storing depressions 313. Thus, the bottom surface of the optical element 40 is separated from the bottom surface (which substantially agrees with the main surface of the wiring substrate) of the connector housing 311 by a predetermined distance. Then, the optical element 40 can be stored therein. The amount of space between the bottom surface of the connector housing 311 and the bottom surface of the optical element 40 is defined in consideration of a space required for the lead terminal of the optical element to be held like the first embodiment.

Each of the optical elements 40 within the respective element-storing depression 13 is held so as to be connected to the optical fiber held at the optical connector of the other party. In other words, two sleeve portions 314 project toward the front of the housing body portion 312. When the optical connector of the other party is connected to the optical connector 310, each of the ferrule portions of the optical connector of the other party is laid within the respective sleeve portion 314 and is guided toward the optical element 40 of the respective element-storing depression 313, like the first embodiment. The optical fiber within each of the ferrule portions optically connects to the respective optical element 40.

The element-storing depression 313 opens toward the bottom surface side of the connector housing 311. The optical element 40 is inserted from the bottom surface side into the respective element-storing depression 313 such that the optical element 40 can be stored and held in a predetermined position where the light-receiving or light-emitting surface can face forward. The front surface within the element-storing depression 313 has a projection 313b corresponding to the bottom position of the optical element 40 provided within the element-storing depression 313. The optical element 40 is pressed into the element-storing depression 313, and the optical element 40 is slidably in contact with the projection 313b. Then, the optical element 40 is laid within the element-storing depression 313. Thus, the front edge part of the bottom of the optical element 40 associates with the projection 313b, which can be secured to the bottom of the optical element 40.

A lead frame 22 is provided in the inner radius surface of each of the element-storing depressions 313. More specifically, a frame storing slot portion 320g is provided vertically on the surface facing the electrode portion 40b in the inner radius surface of each of the element-storing depressions 313, i.e., on the back side. The lead frame 22 is mounted to the frame storing slot portion 320g. The lead frame 22 has the same construction as that of the lead frame 22 according to the first embodiment.

The connecting portion 23 on one end of the lead frame 22 is provided at a position, which can be in contact with the electrode portion 40b of the optical element 40 stored within the element-storing depression 313. The soldering portion 24 on the other end is exposed to the outside of the connector housing 311 and is mounted to the inner radius surface of the element-storing depression 313 in a position and attitude suitable for the soldering to the wiring pattern of the wiring substrate.

The optical element 40 is pressed into the element-storing depression 313 through an opening at the bottom surface. Thus, the top of the bend-forcing portion 23a is press-fitted to the back surface of the optical element 40, and the bend-forcing portion 23a is elastically deformed into a flat form. When the optical element 40 is completely pressed into the element-storing depression 313, the bend-forcing portion 23a is pressed and is forced to the electrode 40b with the elasticity of the bend-forcing portion 23a for returning to the original form. Furthermore, when the optical connector 310 is provided on the wiring substrate, the soldering portion 24 can be in contact with and soldered to the wiring pattern on the wiring substrate.

The connecting tube portion 316 having the same construction as that of the connecting tube portion 16 extends so as to enclose both of the sleeve portions 314 from the outer radius part of the housing body portion 312. Furthermore, screwed portions 317 having the same construction as that of the screwed portion 17 project on both sides of the outer radius part of the housing body portion 312.

The optical connector 310 is implemented on the wiring substrate like the optical connector 10 according to the first embodiment. In the optical connector 310 having the above-described construction, the connecting portion 23 on one end of the lead frame 22 in the inner radius part of the element-storing depression 313 is electrically connected to the electrode portion 40b of the optical element 40 within the element-storing depression 313. Furthermore, the soldering portion 24 on the other end of the lead frame 22 can be soldered to the wiring pattern of the wiring substrate. Therefore, the surface-implemented type optical element 40 held at a position apart from the wiring substrate by a predetermined distance and the wiring pattern of the wiring substrate 70 can be electrically connected.

Thus, only by slightly deforming a conventional optical connector designed to provide the optical element body portion at a position apart from the substrate based on the premise that the optical connector includes an optical element with a lead terminal, the optical connector for the surface-implemented type optical element 40 can be manufactured. The optical connector of the other party connecting thereto may have the same construction as the conventionally used one.

Like the first embodiment, the connecting portion 23 is press-forced against the electrode portion 40b. Therefore, the connection reliability between the connecting portion 23 and the electrode portion 40b can be obtained. Furthermore, the optical element 40 having a slightly different size and/or form can be addressed. The lead frame 22 may adopt the same construction as the variation example shown in FIGS. 7 and 8.

The optical connector 310 according to the second embodiment is of a so-called bipolar type optical connector. In addition, the optical connector having one pole or three or more poles is applicable.

As described above, in an optical connector according to the second embodiment, the connecting portion of one end of the lead frame provided in the lid portion is electrically connected to the electrode portion of the optical element within the element-storing depression. The soldering portion of the other end of the lead frame can be soldered to the wiring pattern of the wiring substrate. Therefore, the surface-implemented type optical element held at a position apart from the wiring substrate by a predetermined distance and the wiring pattern of the wiring substrate can be electrically connected.

In an optical connector according to the second embodiment of this invention, the connecting portion on one end of the lead frame provided in the inner radius part of the element-storing depression is electrically connected to the electrode portion of the optical element within the element-storing depression. Furthermore, the soldering portion on the other end of the lead frame can be soldered to the wiring pattern of the wiring substrate. Therefore, the surface-implemented type optical element held at a position apart from the wiring substrate by a predetermined distance and the wiring pattern of the wiring substrate can be electrically connected.

With the second embodiment, the connecting portion is press-forced against the electrode portion of an optical element by the forcing portion. Therefore, the connection reliability between the connecting portion and the electrode portion can be obtained.

Third Embodiment

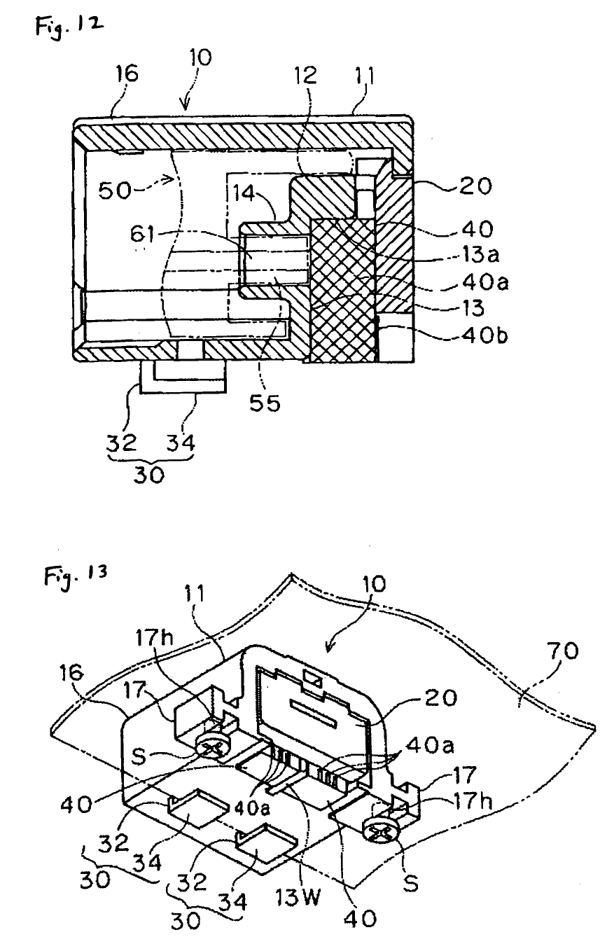

An optical connector according to a third embodiment of the invention will be described below. FIG. 12 is a section diagram showing an optical connector. FIG. 13 is a perspective diagram for describing a state where the optical connector is mounted to a wiring substrate.

An optical connector 10 contains an optical element 40 and is implemented on a wiring substrate 70. An optical connector 50 of the other party holding an optical fiber 61 can be connected to the optical connector 10 (see FIG. 12). The optical connector 10 includes an optical element 40, a connector housing 11 and a lid portion 20.

The optical element 40 is a light-receiving element (such as a photo diode and a phototransistor) for converting optical signals to electric signals or a light-emitting element (such as a light-emitting diode) for converting electric signals to optical signals. The optical element 40 is of the surface-mounted type, i.e., the optical element 40 has an electrode portion 40b on the surface of an optical element body portion 40a. More specifically, the optical element 40 has the thin-band-shaped electrode portion 40b on the lower back of the element body portion 40a (see FIG. 12). According to this embodiment, the optical connector 10 has two optical elements 40.

The connector housing 11 contains resin and two element-storing depressions 13, which can store and hold the optical elements 40. More specifically, the connector housing 11 includes the housing body portion 12, a guide sleeve portion 14 and a connecting tube portion 16. The housing body portion 12 contains two element-storing depressions 13, each of which can store each of the optical elements 40. These two element-storing depressions 13 are separated by a separating wall 13W.

The element-storing depression 13 is provided so as to store and hold the optical element 40 such that the optical element 40 can be surface-mounted on the upper surface, which is one main surface, of the wiring substrate 70. In other words, the height of the element-storing depression 13 is substantially the same as the height of the optical element 40. When the optical elements 40 is stored in the optical element-storing depression 13 such that the upper surface of each of the optical element 40 can be abutted to the ceiling surface 13a of each of the element-storing depressions 13, the bottom surface of the optical element 40 is provided at a position where the bottom surface of the optical element 40 substantially agrees with the bottom surface of the connector housing 11. Therefore, when the optical connector 10 is provided on the wiring substrate 70 such that the bottom surface of the connector housing 11 can be tightly in contact with the upper surface of the wiring substrate 70, the optical element 40 is provided tightly on the upper surface of the wiring substrate 70. Thus, the electrode portion 40b of the optical element 40 can be soldered to a wiring pattern, which is formed by flow soldering method, for example, on the upper surface of the wiring substrate 70.

The element-storing depression 13 opens toward the back side (opposite side of the side to which the optical connector 50 of the other party is connected) of the connector housing 11. The optical element 40 is stored in the element-storing depression 13 and the light-receiving surface or light-emitting surface of the optical element 40 faces the front. Then, the back side opening portion of the element-storing depression 13 is closed with the lid portion 20. The optical element 40 is held at a predetermined position within the element-storing depression 13 such that the optical element 40 is pressed forward by the lid portion 20.

Two guide sleeve portions 14 project on the front of the housing body portion 12. Each of the guide sleeve portions 14 has a substantial-tube shape having a hole, through which a ferrule portion 55 can be inserted and which communicates to the inside of each of the element-storing depressions 13. When the optical connector 10 and the optical connector 50 are connected, each of the ferrule portions 55 is inserted to the respective guide sleeve portion 14 and is guided toward the optical element 40 in the respective element-storing depression 13. When each of the ferrule portions 55 is completely inserted to the respective sleeve portion 14, the end front of the optical fiber 61 faces toward and optically connects to the light-emitting or light-receiving surface of the respective optical element 40.

The connecting tube portion 16 extends so as to enclose both of the guide sleeve portions 14 from the outer radius part of the housing body portion 12. The connecting tube portion 16 substantially has a tube-shape, to which the optical connector 50 of the other party can internally fit.

Furthermore, screwed portions 17 project on both sides of the outer radius part of the housing body portion 12. Each of the screwed portions 17 has a screw hole 17h. Two lock-associating portions 30 are integrally provided on the bottom surface side of the connector housing 11. These two lock-associating portions are provided in parallel in the width direction of the connector housing 11 a predetermined distance apart.

The lock-associating portion 30 includes a member having a substantial L-shaped side and including a support piece 32 and a lock piece 34. The lock piece 34 is a member having a substantial square shaped bottom surface and extends toward the bottom surface of the connector housing 11. The lock piece 34 can be abutted to and associate with the bottom surface, which is the other main surface, of the wiring substrate 70.

The support piece 32 is a member projecting, in a drop shape, from the bottom surface of the connector housing 11. The support piece 32 supports the lock piece 34 like a cantilever at a position separated from the bottom surface side of the connector housing 11 by an amount equal to the thickness of the wiring substrate 70. In other words, the distance between the bottom surface of the connector housing 11 and the lock piece 34 is substantially equal to the thickness of the wiring substrate 70. When the bottom surface of the connector housing 11 is abutted to the upper surface of the wiring substrate 70, the lock piece 34 can be abutted to the lower surface of the wiring substrate 70.

Especially, the support piece 32 supports the lock piece 34 at the front edge of the lock piece 34. Therefore, the lock piece 34 extends from the support piece 32 to the back (i.e., in the connection direction of the optical connector 50 of the other party). In other words, the connector housing 11 is slid toward the back (i.e., toward the connection direction of the optical connector 50 of the other party) along the upper surface of the wiring substrate 70. The lock piece 34 can be located at a position where the lock piece 34 can be abutted to the wiring substrate 70.

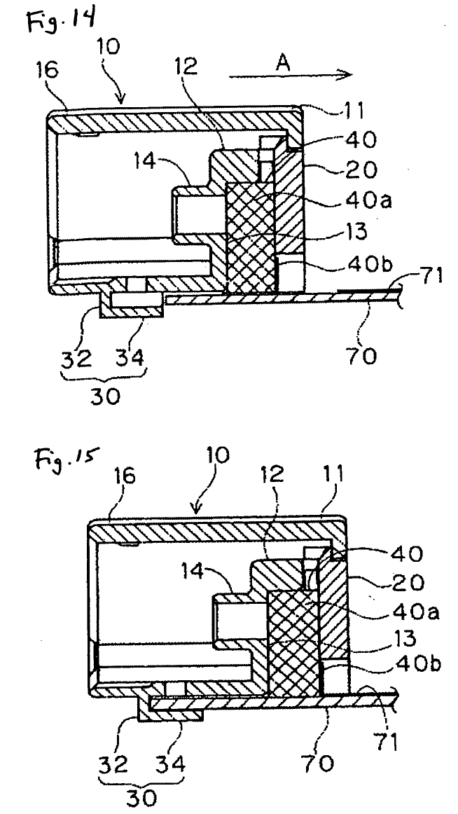

The steps for implementing and fixing the optical connector 10 having the above-described construction to the wiring substrate 70 will be described. First of all, the optical element 40 is stored in the respective element-storing depression 13 of the optical connector 10, and the lid portion 20 is attached thereto. Then, as shown in FIG. 14, the optical connector 10 is provided on the wiring substrate 70 such that the rear part of the bottom surface of the optical connector 10 can be provided tightly on the upper surface of the wiring substrate 70 and such that the lock-associating portion 30 can be provided outside of the wiring substrate 70. The upper surface of the wiring substrate 70 has a wiring pattern 71, as required, to be electrically connected to the electrode portion 40b of the optical element 40.

The bottom surface of the optical connector 10 is slidably in contact with the upper surface of the wiring substrate 70 while the optical connector 10 is slid in the direction indicated by the arrow A. The slide direction A is substantially the same as the connection direction of the optical connector 50 of the other party.

When the optical connector 10 is slid, the side edge of the wiring substrate 70 enters between the bottom surface of the connector housing 11 and the lock piece 34. Thus, the lock piece 34 can be abutted to the lower surface of the side edge of the wiring substrate 70.

Furthermore, as shown in FIG. 15, the optical connector 10 is slid until the side edge of the wiring substrate 70 is abutted to the support piece 32. Thus, the electrode portion 40b of the optical element 40 is provided on the wiring pattern 71 of the wiring substrate 70 at a position allowing the soldering by reflow-soldering, for example.

Then, after the screwed portion 17 is screwed to the wiring substrate 70 with a screw S, the electrode portion 40b of the optical element 40 is soldered to the wiring pattern 71 of the wiring substrate 70 or vise versa (i.e., screwing after the soldering). Thus, the implementation and securing of the optical connector 10 to the wiring substrate 70 is ended.

In the optical connector 10 having the above described construction, the lock piece 34 can be abutted to and lockably associated with the lower surface of the wiring substrate 70 by sliding the connector housing 11. Therefore, even when a force is applied to the optical connector 10 in a direction for lifting from the wiring substrate 70, the force can be received by the lock piece 34. The strength of the optical connector 10 in the lifting direction from the wiring substrate 70 can be increased. Thus, the stress to be applied to the soldering part between the optical element 40 and the wiring patter 71 is reduced, and the soldering cracks and the like can be prevented. Then, the reliability of the electric connection can be improved.

Because the optical element 40 is of the surface-mounted type, the connector housing 11 can be slid without problems even when the optical connector 40 is stored in the connector housing 11. In this case, the optical connector using an optical element with a lead like a conventional one cannot be slid on the wiring substrate because the lead becomes an obstacle.

Furthermore, the lock piece 34 extends from the support piece 32 to the back, i.e., in the connection direction of the optical connector 50 of the other party. Therefore, in order to associate the lock piece 34 to the lower surface of the wiring substrate 70, the connector housing 11 is slid backward on the wiring substrate 70. Here, by abutting the support piece 32 to the edge of the wiring substrate 70, the force acting when an optical connector of the other party is connected thereto is received by the abutting part between the support piece 32 and the edge of the wiring substrate 70. Thus, the external force to be applied to the optical element 40 and the wiring pattern 71 can be reduced. Also because of this, the soldering cracks and the like can be prevented, and the reliability of the electric connection can be improved.

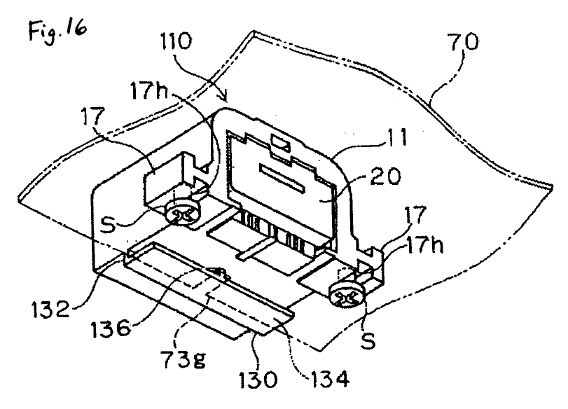

FIG. 16 is a perspective diagram showing an optical connector 110 according to a variation example. In the optical connector 110, a single lock-associating portion 130 is integrally provided on the bottom surface side of the connector housing 11. The lock-associating portion 130 is provided in a member having a substantial L-shaped side and having a support piece 132 and a lock piece 134.

The lock piece 134 is a plate-like member having a substantially rectangular bottom surface having a longer side in the width direction of the connector housing 11. Like the lock piece 34, the lock piece 135 extends from the support piece 132 to the back in the bottom surface direction of the connector housing 11 and is slid toward the back. Thus, the lock piece 134 can be abutted to and associated with the lower surface of the wiring substrate 70.

The support piece 132 is a member projecting, in a drop shape, from the bottom surface of the connector housing 11. Like the support piece 32, the lock piece 134 is supported like a cantilever at a position separated from the bottom surface side of the connector housing 11 by a distance equal to the thickness of the wiring substrate 70.

The lock-associating portion 130 includes a positioning associating portion 136 between the bottom surface of the connector housing 11 and the lock piece 134. The positioning associating portion 136 is provided in the middle part of the lock piece 134 in the extending direction and is integrally provided to the connector housing 11, lock piece 134, and support piece 132.

In order to implement and fix the optical connector 110 to the wiring substrate 70, a notch-like associating slot 73g to which the positioning associating portion 136 can be inserted is provided in the wiring substrate 70 in advance. When the optical connector 110 is slid on the wiring substrate 70, the positioning associating portion 136 is inserted to the associating slot 73g. The other steps are performed in the same manner as those for implementing and fixing the optical connector 10 on the wiring substrate 70.

In addition to the above-described advantages, the positioning of the optical connector 110 in the width direction can be achieved in the optical connector 110 according to the variation example by associating the positioning associating portion 136 with the associating slot 73g on the side of the wiring substrate 70.

Furthermore, the lock piece 134 is supported also by the positioning associating portion 136 at a position separated from the bottom surface of the connector housing 11 by a predetermined distance. When an excessive force is applied to the optical connector 110 in the lifting direction from the wiring substrate 70, the elastic deformation of the lock-associating portion 130 can be securely prevented. Therefore, the strength in the lifting direction from the wiring substrate 70 can be improved.

According to the third embodiment and the variation example, the optical connectors 10 and 110 are implemented and are fixed on the side of the wiring substrate 70. However, the optical connectors 10 and 110 can be implemented and fixed at a position different from the side of the wiring substrate 70.

In this case, associating holes through which the lock-associating portions 30 and 130 can be removably inserted may be provided on the wiring substrate 70 in advance. Then, when the lock-associating portions 30 and 130 are removably inserted through the associating holes, the optical connectors 10 and 110 are slid. Thus, the lock pieces 34 and 134 can be associated with the lower surface of the wiring substrate 70 at the peripheral edge of the associating holes.

According to the above-described third embodiment and the variation example, the optical connector 10 is of a so-called bipolar type including two optical elements 40. However, the optical connector having one pole or three or more poles is applicable.

As described above, in an optical connector of the third embodiment, the lock portion can be lockably associated with the other main surface of the wiring substrate by sliding the connector housing on the wiring substrate. Therefore, the strength of the optical connector in the lifting direction from the wiring substrate can be increased.

Furthermore, the lock portion extends from the support portion in the connection direction of the optical connector of the other party. Therefore, the lock portion can be associated with the other main surface of the wiring substrate by sliding the connector housing on the wiring substrate in the connection direction of the optical connector of the other party. Here, by abutting the support portion to the edge of the wiring substrate, the force acting when an optical connector of the other party is connected can be received by the abutting part between the support portion and the edge of the wiring substrate.

In the third embodiment of the invention, by associating a positioning associating portion with the notch portion of the wiring substrate, the positioning of the optical connector can be achieved.

Fourth Embodiment

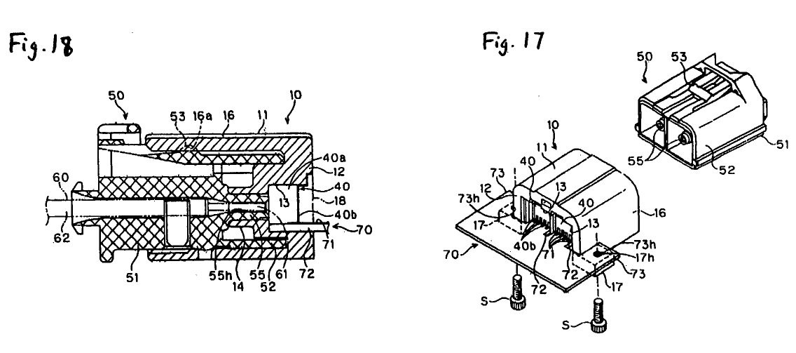

An optical connector according to a fourth embodiment of the invention will be described below. FIG. 17 is a perspective diagram showing an optical connector according to an embodiment and an optical connector of the other party, which is connected thereto. FIG. 18 is a section diagram showing a connection state of both optical connectors.

An optical connector 10 stores two optical elements 40 and is implemented on the wiring substrate 70. The optical connector 10 can be connected to an optical connector 50 of the other party storing and holding two optical fibers 61. Here, the optical connector 50 of the other party contains resin, for example, and two ferrule portions 55 are integrated to a housing body portion 51.

Two cord storing holes 51h, which can internally hold optical fiber cords 60, are provided in the housing body portion 51. The two ferrule portions 55 project on the front of the housing body portion 51. Each of the ferrule portions 55 has a fiber storing hole 55h, which can internally hold the optical fiber 61 exposing at the end of the optical fiber cord 60 on the extension of the cord storing hole 51h. When the two optical fiber cords 60 exposing optical fibers 61 at the ends are inserted from the back of the housing body portion 51 into the cord storing holes 51h, the optical fibers 61 exposing at the ends are stored and are held within the fiber storing holes 55h. The frontward part of cover portions 62 are stored and are held within the cord storing holes 51h. When the optical fibers 61 are laid within the ferrule portions 55, the end fronts of the optical fibers 61 are mirror-finished at the pointed ends of the ferrule portions 55.

A protection tube portion 52 is provided at the pointed end of the housing body portion 51 by enclosing the ferrule portions 55. Especially, the protection tube portion 52 extends from the ferrule portions 55 to the pointed end by entirely and externally enclosing the ferrule portions 55. Therefore, when the optical connector 10 is not connected thereto, the end fronts of the optical fibers 61 exposing at the pointed ends of the ferrule portions 55 are provided at the deepest positions within the protection tube portion 52. Thus, the occurrence of wear and tear to the end fronts of the optical fibers 61 can be prevented.

A latch piece 53, which can associate with an associated portion 16a of the optical connector 10, is provided on the upper part of the housing body portion 51. The optical connector 10 includes the optical elements 40 and a connector housing 11.

In other words, the optical element 40 is a light-receiving element (such as a photo diode and a phototransistor) for converting optical signals to electric signals or a light-emitting element (such as a light-emitting diode) for converting electric signals to optical signals. The optical element 40 is of the surface-mounted type to the wiring substrate 70. According to the fourth embodiment, the optical element 40 has an electrode portion 40b on the surface of an optical-element body portion 40a.

More specifically, the optical element 40 has the thin-band-shaped electrode portion 40b substantially in an L-shape on the part from the lower back of the optical element body portion 40a in a substantial cuboid shape to the bottom surface. After a soldering paste is coated on the wiring pattern 71 on the surface of the wiring substrate 70, the soldering paste is exposed in a high temperature atmosphere and is melted while the optical element 40 is provided on the wiring substrate 70. Then, the electrode portion 40b and the wiring pattern 71 are soldered, and the optical element 40 is surface-mounted on the wiring substrate 70.

According to this fourth embodiment, the optical connector 10 includes two optical elements 40. The connector housing 11 stores the implementation-extending portion 72 (which will be described later) of the wiring substrate 70 and the optical elements 40 in a state (position and attitude) optically connectable to the optical fiber 61 of the optical connector 50 of the other party. The connector housing 11 preferably contains conductive resin. The resin contains a conductive filler or a conductive material of copper or alloys of copper. More specifically, the connector housing 11 includes the housing body portion 12, the sleeve portion 14 and the connecting tube portion 16.

Two element-storing depressions 13, which can store the optical elements 40 and the implementation-extending portions 72 of the wiring substrate 70, are provided in the housing body portion 12. The element-storing depression 13 opens toward the back side (opposite side of the side to which the optical connector 50 of the other party is connected) of the connector housing 11. The optical element 40 and the implementation-extending portion 72 are inserted from the back side into the respective element-storing depression 13 such that the optical element 40 can be stored and held in a predetermined position where the light-receiving or light-emitting surface can face forward. The optical element 40 in the element-storing depression 13 is enclosed in all directions by the housing body portion 12. When the optical element 40 is stored within the element-storing depression 13, the opening on the back of the element-storing depression 13 is closed by a lid portion 18 (see FIG. 18). The lid portion 18 also preferably contains a conductive material.

Two sleeve portions 14 project on the front of the housing body portion 12. Each of the sleeve portions 14 has a substantial-tube shape having a hole, through which the ferrule portion 55 can be inserted and which communicates to the inside of each of the element-storing depression 13. When the optical connector 10 and the optical connector 50 are connected, each of the ferrule portions 55 is inserted to the respective sleeve portion 14 and is guided toward the optical element 40 in the respective element-storing depression 13. When each of the ferrule portions 55 is completely inserted to the respective sleeve portion 14, the end front of the optical fiber 61 faces toward and optically connects to the light-emitting or light-receiving surface of the respective optical element 40.

The connecting tube portion 16 extends so as to enclose both of the sleeve portions 14 from the outer part of the housing body portion 12. The connecting tube portion 16 substantially has a tube-shape, to which the optical connector 50 of the other party can internally fit. A latched portion 16a, which can associate with a latch piece 53 of the optical connector 50 side of the other party, is provided on the upper part of the connecting tube portion 16. When the optical connector 50 is internally fitted and is connected to the connecting tube portion 16, the latch piece 53 is associated with the latched portion 16a. Thus, the connection state between the optical connector 10 and the optical connector 50 can be maintained. Furthermore, screwed portions 17 project on both sides of the outer part of the housing body portion 12. Each of the screwed portions 17 has a screw hole 17h.

The wiring substrate 70 has a predetermined wiring pattern with a printed wiring at least on the surface, and electronic parts are implemented on the wiring substrate 70 as required. For example, a driving circuit for driving the optical element 40 is provided on the wiring substrate 70.

Two implementation-extending portions 72 corresponding to the element-storing depressions 13 and two mount extending portions 73 corresponding to the screwed portion 17 are provided on one side of the wiring substrate 70. Each of the implementation-extending portion 72 is provided in the respective element-storing depression 13 and has a form, which can be inserted to the element-storing depression 13 from the back side. The wiring pattern 71 to which an electrode portion Da of the optical element 40 is electrically connected is provided on the surface. Each of the mount extending portions 73 has a screw insert hole 73h.

In order to assemble the optical connector 10, the electrode portion Da of the optical element 40 is electrically connected by reflow soldering, for example, to the wiring pattern 71 of the implementation-extending portion 72. Then, the optical element 40 is surface-mounted to the respective implementation-extending portion 72. Under this condition, the optical element 40 and the respective implementation-extending portion 72 are laid within the element-storing depression 13, and the mount extending portion 73 is provided over the screwed portion 17.

Under this condition, two screws S are inserted to the screw insert holes 73h of the mount extending portions 73, and are screwed to the screw holes 17h of the screwed portions 17. Furthermore, the openings on the back of the element-storing depressions 13 are closed by the lid portions 18.

Thus, the optical connector 10 mounted to the wiring substrate 70 is assembled. The optical connector 50 of the other party is inserted and is connected to the optical connector 10 horizontally with respect to the planer direction of the wiring substrate 70.

In the optical connector 10 having the above-described construction of the fourth embodiment, the optical element 40 and the part of the wiring substrate 70 where the optical element 40 is surface-mounted, that is the implementation-extending portion 72, are stored in the connector housing 11. Therefore, a longer lead terminal, which may cause the occurrence or entry of noise like the conventional one, does not exist between the optical element and the wiring substrate. In other words, in the optical connector 10, the size of the connecting part between the optical element 40 and the wiring of the wiring substrate 70 can be reduced as much as possible, and excellent noise resistance can be obtained.

Furthermore, the optical element 40, the implementation-extending portion 72 of the wiring substrate 70 and the connecting part are stored within the connector housing 11 and under the lid portion 18. In addition, the connector housing 11 and the lid portion 18 contain a conductive material such as a conductive resin material. Thus, the occurrence or entry of noise from the optical element 40, the implementation-extending portion 72 of the wiring substrate 70 and the connecting part can be securely prevented. For easy assembly, the optical element 40 surface-mounted on the implementation-extending portion 72 may be inserted to the element storing portion 13 from the back.

According to this fourth embodiment, the optical element 40 is of the surface-mounted type. However, even when an optical element with a lead terminal, i.e., a so-called vertically-mounted type optical element is used, the same effect can be obtained with the construction below. In the optical connector, the optical element 40 and the implementation-extending portion 72, which is the implemented part of the wiring substrate 70, is stored in the connector housing 11. Thus, the size of the electric connection element (such as the electrode portion 40b) between the optical element 40 side and the side of the wiring substrate 70 can be reduced as much as possible.

Therefore, even when an optical element with a lead terminal is used, the same effect as that of the above-described embodiment using the surface-mounted type optical element 40 can be obtained by relatively reducing the length of the lead terminal and more specifically by reducing the length of the lead terminal such that the optical element 40 and the implemented part of the wiring substrate 70 can be stored in the connector housing 11.

In an optical connector storing an optical element with a longer lead terminal like a conventional one, the lead terminal extends from the optical element toward the wiring substrate. Thus, the lead terminal disturbs the connection with the optical connector of the other party. In this case, for example, a technology for cutting out the part of the protection tube portion of the optical connector of the other party, which interferes with the lead terminal, may be considered. Alternatively, a technology may be considered for reducing the length of the entire protection tube portion so as to prevent the interference with the lead terminal and for reducing the length of the ferrule portion so as to prevent projections from the protection tube portion.

In the former technology, the function for protecting the optical fiber end front of the pointed end of the ferrule portion is not enough since a part of the protection tube portion is cut out. In the latter technology, the length of the ferrule portion must be reduced. Thus, the optical fiber end of the pointed end side of the ferrule portion does not reach the conventional optical element. Therefore, a light-guiding path for relay must be used, which may cause an increase in loss of light.

However, in the optical connector 10, no lead terminals extend from the optical element 40. A part of the protection tube portion does not have to be cut out in the optical connector 50 of the other party. Thus, the end front of the optical fiber 61 can be protected. Furthermore, the connection does not have to be obtained by using a light-guide path for relay with a shorter ferrule portion. Therefore, effects such as the reduction in light loss, the reduction of the number of components, the increase in connection efficiency and/or the assembly work efficiency and the reduction of costs can be achieved.

According to the fourth embodiment, the optical connector 10 is of the so-called bipolar type including two optical elements 40 to which optical fibers 61 are optically connected. However, the one polar type or three or more polar type optical connector may be also applied.

As described above, in the optical connector of the fourth embodiment, a part of a wiring substrate where an optical element is implemented and an optical element are stored in the connector housing. Thus, the connecting part between the optical element and the wiring of the wiring substrate, which may cause the occurrence or entry of noise, can be reduced in size as much as possible. Therefore, excellent noise resistance can be obtained.

In particular, the connector housing contains a conductive material. Thus, the occurrence or entry of noise from an optical element, for example, can be more securely prevented.

Furthermore, in an optical connector, an optical element implemented on an implementation-extending portion can be inserted together with the implementation-extending portion to an optical element storing portion from the back. Thus, easy assembly can be performed.

While this invention has been described in conjunction with exemplary embodiments outlined above, many alternatives, modifications and variations will be apparent to those skilled in the art. Accordingly, the exemplary embodiments of the invention, as set forth above, are intended to be illustrative, not limiting. Various changes can be made without departing from the spirit and scope of the invention.

What is claimed is:

1. An optical connector storing an optical element and being implemented on a wiring substrate, the optical connector comprising:
a surface-implemented type optical element having an optical element body portion and an electrode portion provided in the optical element body portion;
a connector housing, which can store and hold the optical element so as to optically connect the optical element to an optical fiber held in an optical connector of an other party at a position apart from a main surface of the wiring substrate by a predetermined distance and which has an element-storing depression having an opening on the back;
a lid portion for closing the opening on the back of the element-storing depression; and
a lead frame mounted to the lid portion and having a connecting portion electrically connected to an electrode portion of an optical element stored in the element-storing depression on a first end and a soldering portion, which can be soldered to a wiring of the wiring substrate, on a second end.

2. The optical connector storing an optical element and being implemented on a wiring substrate, the optical connector comprising:
a surface-implemented type optical element having an optical element body portion and an electrode portion provided in the optical element body portion;
a connector housing, which can store and hold the optical element so as to optically connect the optical element to an optical fiber held in an optical connector of an other party at a position apart from a main surface of the wiring substrate by a predetermined distance and which has an element-storing depression having on a bottom side an opening to which the optical element can be inserted; and
a lead frame, provided on the inner radius surface of the element-storing depression, having a connecting portion electrically connected to the electrode portion of the optical element stored in the element-storing depression on a first end and a soldering portion, which can be soldered to a wiring of the wiring substrate, on a second end.

3. The optical connector according to claim 1, wherein the lead frame has a forcing portion for press-forcing the connecting portion to the electrode portion of the optical element.

4. The optical connector according to claim 2, wherein the lead frame has a forcing portion for press-forcing the connecting portion to the electrode portion of the optical element.

5. An optical connector storing an optical element and being implemented on a wiring substrate, the optical connector comprising:
a surface-mounted type optical element; and
a connector housing having an element-storing depression for storing and holding the optical element, which can be surface-mounted onto a first main surface of the wiring substrate, wherein
a bottom surface side of the connector housing has a lock-associating portion having a lock portion, which extends toward the bottom surface side and which can associate with a second main surface side of the wiring substrate, and
a support portion for supporting the lock piece at a position separated from the bottom surface side of the connector housing by the amount equal to the thickness of the wiring substrate.

6. The optical connector according to claim 5, wherein the lock portion extends from the support portion in the connection direction of an optical connector of an other party.

7. The optical connector according to claim 6, wherein a positioning associating portion is provided between the bottom surface side of the connector housing and the lock portion.

8. An optical connector storing an optical element and being implemented on a wiring substrate, the optical connector comprising:
an optical element having an element body portion and a connecting portion; and
a connector housing storing and holding the optical element so as to optically connect the optical element to an optical fiber held in an optical connector of an other party,
wherein the optical element is implemented on the wiring substrate, and the part of the wiring substrate where the optical element is implemented and the optical element are stored in the connector housing.

9. The optical connector according to claim 8, wherein the connector housing contains a conductive material.

10. The optical connector according to claim 8, wherein
the connector housing has an element-storing depression, which opens at the back, and the wiring substrate has an implementation-extending portion to be inserted to the element-storing depression, and
the optical element is implemented to the implementation-extending portion and is stored together with the implementation-extending portion in an optical element storing portion by being inserted from the back.

11. The optical connector according to claim 9, wherein
the connector housing has an element-storing depression, which opens at the back, and the wiring substrate has an implementation-extending portion to be inserted to the element-storing depression, and
the optical element is implemented to the implementation-extending portion and is stored together with the implementation-extending portion in an optical element storing portion by being inserted from the back.
